(19) United States
(12) Patent Application Publication
(10) Pub. No.: US 2017/0134999 A1
(43) Pub. Date: May 11, 2017

(54) METHOD AND APPARATUS FOR ALLOCATING D2D RESOURCE IN A HANDOVER PROCEDURE AND COMMUNICATION SYSTEM

(71) Applicant: FUJITSU LIMITED, Kawasaki-shi (JP)

(72) Inventors: Lianhai WU, Beijing (CN); Haibo XU, Beijing (CN); Yanling LU, Beijing (CN); Hua ZHOU, Beijing (CN)

(73) Assignee: FUJITSU LIMITED, Kawasaki-shi (JP)

(21) Appl. No.: 15/412,723

(22) Filed: Jan. 23, 2017

Related U.S. Application Data
(63) Continuation of application No. PCT/CN2014/083288, filed on Jul. 30, 2014.

(51) Int. Cl. H04W 36/00; H04W 48/16; H04W 76/02

(52) U.S. Cl. CPC H04W 36/0072; H04W 76/023; H04W 48/16

(57) ABSTRACT

Embodiments of the present disclosure provide a method and apparatus for allocating D2D resource in a handover procedure and a communication system. The method for allocating D2D resource in a handover procedure includes: a handover request containing handover preparation information is transmitted by a source base station to a target base station; the handover preparation information comprises auxiliary information for assisting the target base station in D2D resource configuration. Through the embodiments of the present disclosure, in a scenario where the user equipment performs D2D discovery or D2D communication, the target base station may accurately allocate suitable D2D resources even though a handover occurs.

### CROSS REFERENCE TO RELATED APPLICATIONS

This application is a continuation application of International Application PCT/CN2014/083288 filed on Jul. 30, 2014, the entire contents of which are incorporated herein by reference.

### TECHNICAL FIELD

The present disclosure relates to the field of communications, and in particular to a method and apparatus for allocating D2D (Device to Device) resource in a handover procedure and a communication system.

### BACKGROUND

A D2D communication mode refers to that packets need not to pass through a core network and a base station, and a communication link is directly established between user equipment (such as UE1 and UE2) and communication is performed. Before performing D2D communication, a D2D discovery procedure is usually performed. For example, before UE1 transmits information to UE2 in the D2D communication mode, whether UE2 is nearby needs to be discovered first.

FIG. 1 is a schematic diagram of performing D2D discovery or establishing D2D communication by two pieces of UE belonging to the same base station, and FIG. 2 is a schematic diagram of performing D2D discovery or establishing D2D communication by two pieces of UE belonging to different base stations.

For the D2D discovery procedure of the UE, when the UE is triggered to start a D2D discovery process (transmitting a discovery signal or receiving a discovery signal), the UE will notify the base station that it is to perform D2D discovery and requires to be allocated with D2D discovery resources. After receiving the request from the UE, the base station configures the UE with D2D discovery resources. The base station may possibly configure the UE with resources of type1 or type2 via dedicated signaling, or may notify the UE of directly using resources of type1 broadcasted by using a system information block (SIB).

Likewise, when the UE is triggered to need to perform D2D communication, the UE will notify the base station that it is to perform D2D communication and requires to be allocated with D2D communication resources. After receiving the request from the UE, the base station configures the UE with D2D communication resources. The base station may possibly configure the UE with resources of model1 or model2 via dedicated signaling, or may notify the UE of directly using resources of model2 broadcasted by using an SIB.

In performing D2D discovery or D2D communication by the UE, it is possible that handover occurs (the UE is handed over from a source base station to a target base station). During the handover procedure, following issues need to be studied: When should the target base station allocate D2D discovery resources or D2D communication resources? How many D2D discovery resources or D2D communication resources should be allocated by the target base station for the UE? What information should be provided by the source base station for assisting the target base station in performing D2D resource allocation?

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Currently, the source base station provides resource configuration information contained in a handover request message to the target base station, and the target base station makes the allocated resources contained in a handover request acknowledge message according to the information. Or, the D2D resources allocated by the target base station are not transmitted via an X2 interface; and after the UE successfully accesses to the target base station, the UE transmits a resource allocation request to the target base station. However, in comparison with the previous scheme, the obtaining of the resources by the UE in this scheme is slightly delayed.

It was found by the inventors that when the source base station allocates D2D resources, it is possible that a period of validity of the D2D resources is contained. However, in an existing scheme, it is not explained during a handover procedure when the D2D resources are allocated. Hence, in some scenarios, the target base station is unable to accurately allocate suitable D2D resources for the UE.

Embodiments of the present disclosure provide a method and apparatus for allocating D2D resource in a handover procedure and a communication system. In a scenario where the user equipment performs D2D discovery or D2D communication, the target base station may accurately allocate suitable D2D resources even though a handover occurs.

According to a first aspect of the embodiments of the present disclosure, there is provided a method for allocating D2D resource in a handover procedure, including:

transmitting a handover request containing handover preparation information by a source base station to a target base station; wherein, the handover preparation information comprises auxiliary information for assisting the target base station in D2D resource configuration.

According to a second aspect of the embodiments of the present disclosure, there is provided an apparatus for allocating D2D resource in a handover procedure, configured in a resource base station, the apparatus including:

a handover request transmitting unit configured to transmit a handover request containing handover preparation information to a target base station; wherein, the handover preparation information comprises auxiliary information for assisting the target base station in D2D resource configuration.

According to a third aspect of the embodiments of the present disclosure, there is provided a communication system, including:

a source base station configured to transmit a handover request containing handover preparation information to a target base station; wherein, the handover preparation information comprises auxiliary information for assisting the target base station in D2D resource configuration;

the target base station configured to receive the handover request transmitted by the source base station, and transmit a handover request acknowledgement message to the source base station; and

a user equipment configured to be handed over to the target base station from the source base station in performing D2D discovery or D2D communication.

According to another aspect of the embodiments of the present disclosure, there is provided a computer-readable program, wherein when the program is executed in a base station, the program enables a computer to carry out the method for allocating D2D resource in a handover procedure as described above in the base station.

According to a further aspect of the embodiments of the present disclosure, there is provided a storage medium in which a computer-readable program is stored, wherein the computer-readable program enables a computer to carry out the method for allocating D2D resource in a handover procedure as described above in a base station.

An advantage of the embodiments of the present disclosure exists in that by transmitting the auxiliary information for assisting the target base station in D2D resource configuration by the source base station to the target base station, in a scenario where the user equipment performs D2D discovery or D2D communication, the target base station may accurately allocate suitable D2D resources even though a handover occurs.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced in size.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of performing D2D discovery or establishing D2D communication by two pieces of UE belonging to the same base station;

FIG. 2 is a schematic diagram of performing D2D discovery or establishing D2D communication by two pieces of UE belonging to different base stations;

FIG. 3 is a flowchart of the method for allocating D2D resource in a handover procedure according to Embodiment 1 of the present disclosure;

FIG. 4 is a flowchart of a handover procedure according to Embodiment 1 of the present disclosure;

FIG. 5 is a flowchart of the method for allocating D2D resource in a handover procedure according to Embodiment 2 of the present disclosure;

FIG. 6 is a schematic diagram of a structure of the apparatus for allocating D2D resource in a handover procedure according to Embodiment 3 of the present disclosure;

FIG. 7 is a schematic diagram of structure of the base station according to Embodiment 3 of the present disclosure;

FIG. 8 is a schematic diagram of a structure of the apparatus for allocating D2D resource in a handover procedure according to Embodiment 4 of the present disclosure; and

FIG. 9 is a schematic diagram of a structure of the communication system according to Embodiment 5 of the present disclosure.

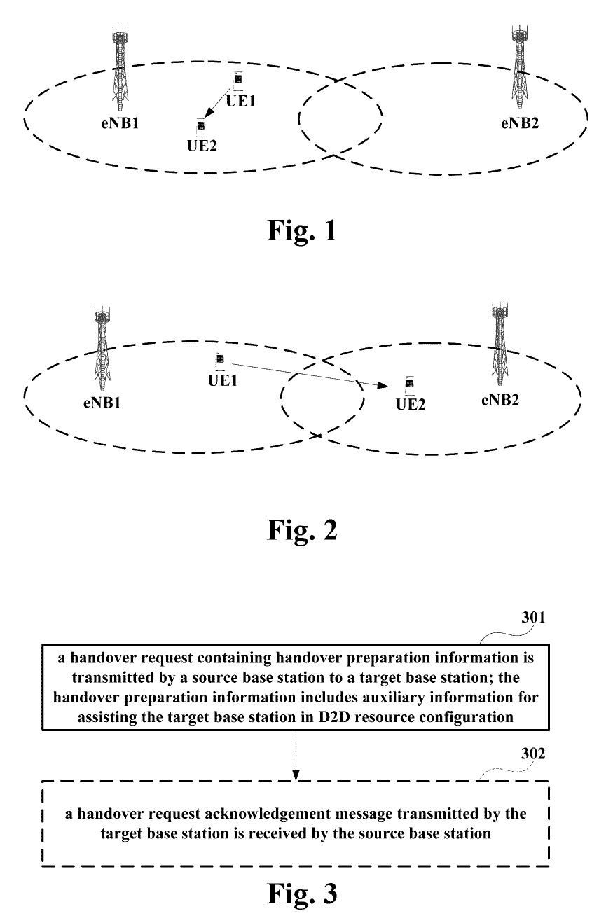

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

### Embodiment 1

An embodiment of the present disclosure provides a method for allocating D2D resource in a handover procedure, applicable to a source base station side during the handover procedure. FIG. 3 is a flowchart of the method for allocating D2D resource in a handover procedure according to the embodiment of the present disclosure. As shown in FIG. 3, the method for allocating D2D resource includes:

step 301: a handover request containing handover preparation information is transmitted by a source base station to a target base station; the handover preparation information includes auxiliary information for assisting the target base station in D2D resource configuration.

In this embodiment, the UE performs D2D discovery or D2D communication, and it is applicable to a scenario where the UE is within a coverage range of the base station, in which the base station configures the UE with D2D discovery resources or D2D communication resources. When a handover occurs, a source base station transmits a handover request message containing HandoverPreparationInformation to a target base station.

In this embodiment, for the sake of convenience of the target base station in configuring resource information, the source base station may possibly make the following auxiliary information contained in the handover request: information related to D2D resource configuration information, and information related to a time for transmitting the D2D resource configuration information. However, the present disclosure is not limited thereto; for example, the handover preparation information may further include more other auxiliary information. And furthermore, the handover request may also contain more other information.

In an implementation, the information related to D2D resource configuration information may be D2D discovery resource configuration information or D2D communication resource configuration information allocated by the source base station for the UE, and the information related to a time for transmitting the D2D resource configuration information includes an elapsed time length value of a time for transmitting the D2D resource configuration information by the source base station relative to a current time (relative time information).

For example, the source base station allocated D2D discovery resources with a valid time period of one hour for the UE at 12:00 on Jul. 23, 2014, and when a handover occurs at a current time (12:30 on Jul. 23, 2014), the source base station transmits the D2D discovery resource configuration information and an elapsed time length value of a time for transmitting the D2D discovery resource configuration information relative to the current time (that is, a relative time period of 30 minutes) to the target base station. Hence, the target base station may learn that a valid time period of the D2D discovery resources is one hour and the D2D discovery resources have been used for 30 minutes. Therefore, the target base station is able to accurately allocate suitable D2D resources, such as allocating D2D discovery resources of only the remaining 30 minutes for the UE.

In another implementation, the information related to D2D resource configuration information may be D2D discovery resource configuration information or D2D communication resource configuration information allocated by the source base station for the UE, and the information related to a time for transmitting the D2D resource configuration information includes an exact time value for transmitting the D2D resource configuration information (absolute time information).

For example, the source base station allocated D2D discovery resources with a valid time period of one hour for the UE at 12:00 on Jul. 23, 2014, and when a handover occurs at a current time (12:30 on Jul. 23, 2014), the source base station transmits the D2D discovery resource configuration information and a time value for transmitting the D2D resource configuration information (that is, an absolute time of 12:00 on Jul. 23, 2014) to the target base station. Hence, the target base station may learn that a valid time period of the D2D discovery resources is one hour and the D2D discovery resources have been used for 30 minutes. Therefore, the target base station is able to accurately allocate suitable D2D resources.

In a further implementation, the information related to D2D resource configuration information may be D2D discovery resource request information or D2D communication resource request information transmitted by the UE, and the information related to a time for transmitting the D2D resource configuration information includes an elapsed time length value of a time for transmitting the D2D resource configuration information by the source base station relative to a current time (relative time information).

For example, the UE transmits the resource request information to the source base station at an air interface, requesting the source base station to configure D2D discovery resources with a valid time period of one hour. According to the resource request information, the source base station configures the UE with the D2D discovery resources with a valid time period of one hour; it is assumed herein that a time for transmitting the configuration information by the source base station is 12:00 on Jul. 23, 2014.

When a handover occurs at a current time (12:30 on Jul. 23, 2014), the source base station transmits the resource request information and an elapsed time length value of a time for transmitting the D2D discovery resource configuration information relative to the current time (that is, a relative time period of 30 minutes) to the target base station. Hence, the target base station may learn that a valid time period of the D2D discovery resources is one hour and the D2D discovery resources have been used for 30 minutes. Therefore, the target base station is able to accurately allocate suitable D2D resources.

In still another implementation, the information related to D2D resource configuration information may be D2D discovery resource request information or D2D communication resource request information transmitted by the UE, and the information related to a time for transmitting the D2D resource configuration information includes an exact time value for transmitting the D2D resource configuration information by the source base station (absolute time information).

For example, the UE transmits the resource request information to the source base station at an air interface, requesting the source base station to configure D2D discovery resources with a valid time period of one hour. According to the resource request information, the source base station configures the UE with the D2D discovery resources with a valid time period of one hour; it is assumed herein that a time for configuring the D2D discovery resources by the source base station is 12:00 on Jul. 23, 2014.

When handover occurs at a current time (12:30 on Jul. 23, 2014), the source base station transmits the resource request information and a value of a time for transmitting the D2D discovery resource configuration information (that is, an absolute time of 12:00 on Jul. 23, 2014) to the target base station. Hence, the target base station may learn that a valid time period of the D2D discovery resources is one hour and the D2D discovery resources have been used for 30 minutes. Therefore, the target base station is able to accurately allocate suitable D2D resources.

In this embodiment, as shown in FIG. 3, the method for allocating D2D resource further may further include:

step 302: a handover request acknowledgement message transmitted by the target base station is received by the source base station.

In an implementation, the handover request acknowledgement message may contain D2D resource information configured by the target base station based on the handover preparation information. That is, the target base station configures the D2D discovery resources or D2D communication resources for the UE based on the auxiliary information from the source base station, and makes the D2D resource configuration information contained in the handover request acknowledgement message.

In another implementation, the handover request acknowledgement message may not contain the D2D resource configuration information, and the target base station notifies the UE of using resources broadcasted in an SIB. That is, the target base station does not contain the D2D resource configuration information in the handover request acknowledgement message, but informs the UE of using the resources broadcasted in the SIB.

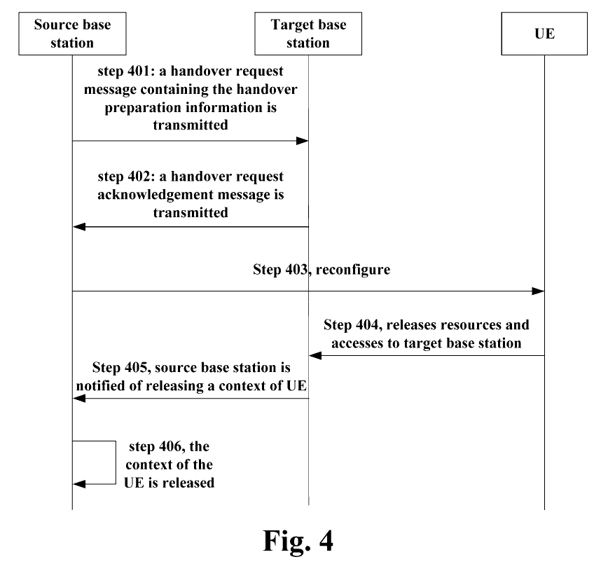

FIG. 4 is a flowchart of the handover procedure according to the embodiment of the present disclosure. As shown in FIG. 4, the handover procedure includes:

step 401: a handover request message containing the handover preparation information is transmitted by the source base station to the target base station;

the handover preparation information includes auxiliary information for assisting the target base station in D2D resource configuration; for example, the auxiliary information may include: the information related to D2D resource configuration information, and the information related to a time for transmitting the D2D resource configuration information, which are as described in step 301 above;

in this embodiment, when the base station configures the D2D resources, a usable valid time period of the D2D resources may possibly contained; if the target base station is notified of only the D2D resource information, but of no transmission time information, the target base station will be unable to accurately configure the D2D resources; likewise, when the UE transmits the resource request information at an air interface, it is also possible that a usable time length of D2D resources suggested to be used is contained, so that the base station would allocate suitable usable valid time period of the D2D resources; hence, if the target base station is notified of only the resource request information, the target base station is unable to accurately configure D2D resources; and the target base station is able to accurately allocate suitable D2D resources through the handover preparation information according to the embodiment of the present disclosure;

step 402: a handover request acknowledgement message is transmitted by the target base station;

the handover request acknowledgement message may contain the D2D resource information configured by the target base station based on the handover preparation information, or may not contain the D2D resource information, as described in step 302 above;

step 403: the UE is reconfigured by the source base station after the source base station receives the handover request acknowledgement message from the target base station;

step 404: D2D resources are released by the UE after the UE receives a reconfiguration message from the source base station, and the UE starts to access to the target base station;

step 405: the source base station is notified by the target base station of releasing a context of the UE after the UE successfully accesses to the target base station; and

step 406: the context of the UE is released by the source base station after the source base station receives a request message from the target base station for releasing the context of the UE.

It should be noted that FIG. 4 only schematically shows details of the handover procedure related to the present disclosure; however, the present disclosure is not limited thereto. The relevant art may further be referred to for particular details of the handover procedure, which shall not be described herein any further.

It can be seen from the above embodiment that by transmitting the auxiliary information for assisting the target base station in D2D resource configuration by the source base station to the target base station, in a scenario where the user equipment performs D2D discovery or D2D communication, the target base station may accurately allocate suitable D2D resources even though a handover occurs.

### Embodiment 2

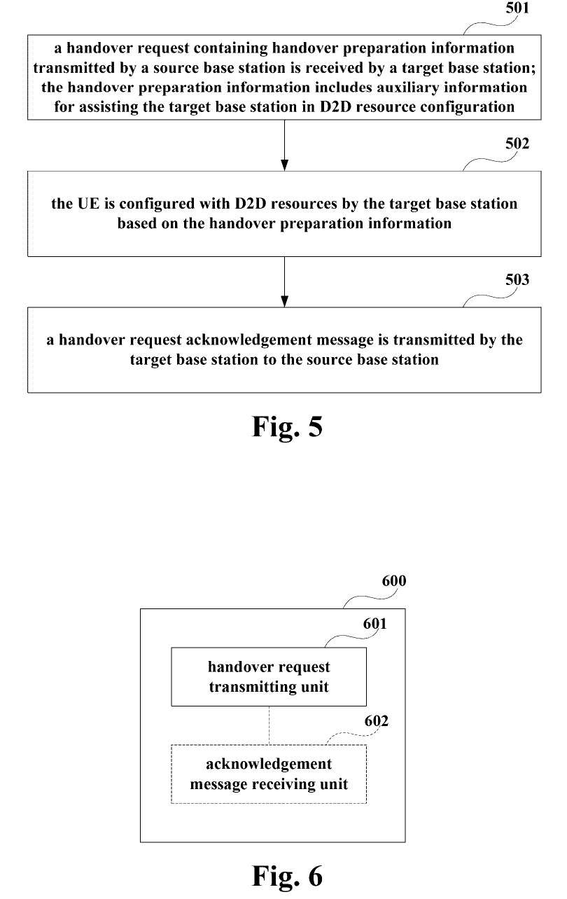

An embodiment of the present disclosure provides a method for allocating D2D resource in a handover procedure, applicable to a target base station side during the handover procedure. FIG. 5 is a flowchart of the method for allocating D2D resource in a handover procedure according to the embodiment of the present disclosure. As shown in FIG. 5, the method for allocating D2D resource includes:

step 501: a handover request containing handover preparation information transmitted by the source base station is received by the target base station; the handover preparation information includes auxiliary information for assisting the target base station in D2D resource configuration;

step 502: the UE is configured with D2D resources by the target base station based on the handover preparation information; and

step 503: a handover request acknowledgement message is transmitted by the target base station to the source base station.

In this embodiment, the handover preparation information contained in the handover request may be that described in Embodiment 1.

The handover request acknowledgement message may contain D2D resource information configured by the target base station based on the handover preparation information; or the handover request acknowledgement message may also not contain the D2D resource information, and the target base station notifies the UE of using resources broadcasted in an SIB.

It can be seen from the above embodiment that by transmitting the auxiliary information for assisting the target base station in D2D resource configuration by the source base station to the target base station, in a scenario where the user equipment performs D2D discovery or D2D communication, the target base station may accurately allocate suitable D2D resources even though a handover occurs.

### Embodiment 3

An embodiment of the present disclosure provides an apparatus for allocating D2D resource in a handover procedure, which is configured in a source base station. This embodiment of the present disclosure corresponds to the method for allocating D2D resource in a handover procedure according to Embodiment 1, with identical contents being not going to be described herein any further.

FIG. 6 is a schematic diagram of a structure of the apparatus for allocating D2D resource in a handover procedure of the embodiment of the present disclosure. As shown in FIG. 6, the apparatus 600 for allocating D2D resource includes: a handover request transmitting unit 601 configured to transmit a handover request containing handover preparation information to a target base station; wherein, the handover preparation information comprises auxiliary information for assisting the target base station in D2D resource configuration.

In this embodiment, the auxiliary information may include: information related to D2D resource configuration information, and information related to a time for transmitting the D2D resource configuration information.

In an implementation, the information related to D2D resource configuration information may be D2D discovery resource configuration information or D2D communication resource configuration information allocated by the source base station for the UE. The information related to a time for transmitting the D2D resource configuration information includes: an elapsed time length value of a time for transmitting the D2D resource configuration information by the source base station relative to a current time (relative time information), or an exact time value for transmitting the D2D resource configuration information by the source base station (absolute time information).

In another implementation, the information related to D2D resource configuration information may be D2D discovery resource request information or D2D communication resource request information transmitted by the UE. The information related to a time for transmitting the D2D resource configuration information includes: an elapsed time length value of a time for transmitting the D2D resource configuration information by the source base station relative to a current time (relative time information), or an exact time value for transmitting the D2D resource configuration information by the source base station (absolute time information).

As shown in FIG. 6, the apparatus 600 for allocating D2D resource may further include: an acknowledgement message receiving unit 602 configured to receive a handover request acknowledgement message transmitted by the target base station.

The handover request acknowledgement message may contain D2D resource information configured by the target base station based on the handover preparation information. Also, the handover request acknowledgement message may not contain the D2D resource information, and the target base station notifies the UE of using a resource broadcasted in an SIB.

An embodiment of the present disclosure provides a base station, including the apparatus 600 for allocating D2D resource as described above.

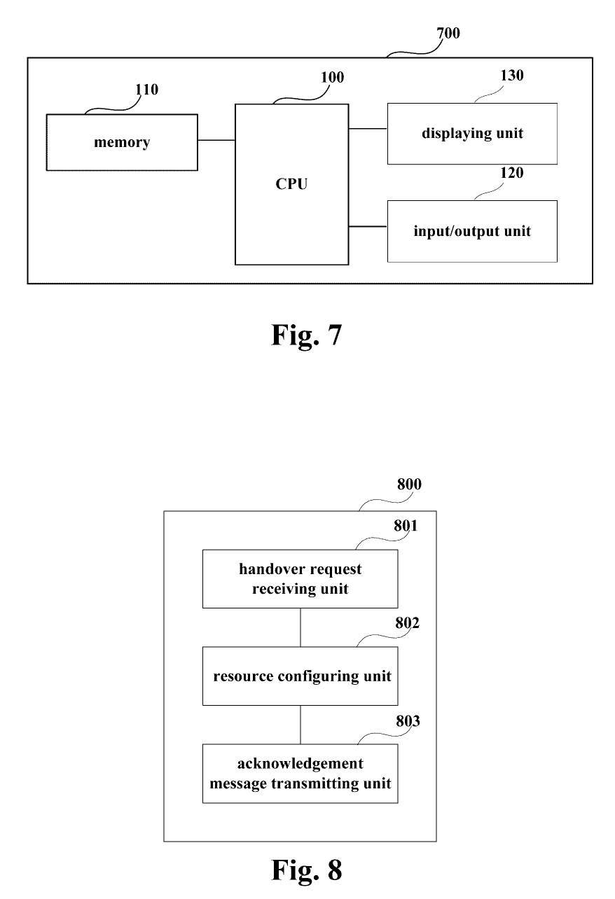

FIG. 7 is a schematic diagram of structure of the base station of the embodiment of the present disclosure. As shown in FIG. 7, the base station 700 may include a central processing unit (CPU) 100 and a memory 110, the memory 110 being coupled to the central processing unit 100. The memory 110 may store various data, and furthermore, it may store a program for information processing, and the program may be executed under control of the central processing unit 100.

In an implementation, the functions of the apparatus 600 for allocating D2D resource may be integrated into the central processing unit 100. The central processing unit 100 may be configured to carry out the method for allocating D2D resource according to Embodiment 1.

In another implementation, the apparatus 600 for allocating D2D resource and the central processing unit may be configured separately. For example, the apparatus 600 for allocating D2D resource may be configured as a chip connected to the central processing unit 100, with its functions being realized under control of the central processing unit 100.

Furthermore, as shown in FIG. 7, the base station 700 may further include an input/output unit 120, and a displaying unit 130, etc. Functions of the above components are similar to those in the relevant art, and shall not be described herein any further. It should be noted that the base station 700 does not necessarily include all the parts shown in FIG. 7, and furthermore, the base station 700 may include parts not shown in FIG. 7. And the relevant art may be referred to for a particular constitution of the base station.

It can be seen from the above embodiment that by transmitting the auxiliary information for assisting the target base station in D2D resource configuration by the source base station to the target base station, in a scenario where the user equipment performs D2D discovery or D2D communication, the target base station may accurately allocate suitable D2D resources even though a handover occurs.

### Embodiment 4

An embodiment of the present disclosure provides an apparatus for allocating D2D resource in a handover procedure, which is configured in a target base station. This embodiment of the present disclosure corresponds to the method for allocating D2D resource in a handover procedure according to Embodiment 2, with identical contents being not going to be described herein any further.

FIG. 8 is a schematic diagram of a structure of the apparatus for allocating D2D resource in a handover procedure of the embodiment of the present disclosure. As shown in FIG. 8, the apparatus 800 for allocating D2D resource includes: a handover request receiving unit 801, a resource configuring unit 802 and an acknowledgement message transmitting unit 803.

The handover request receiving unit 801 is configured to receive a handover request containing handover preparation information transmitted by the source base station; the handover preparation information includes auxiliary information for assisting the target base station in D2D resource configuration; the resource configuring unit 802 is configured to configure D2D resources for UE based on the handover preparation information; and the acknowledgement message transmitting unit 803 is configured to transmit a handover request acknowledgement message to the source base station.

In this embodiment, the auxiliary information may include: information related to D2D resource configuration information, and information related to a time for transmitting the D2D resource configuration information, with detailed contents being as those described in Embodiment 1.

An embodiment of the present disclosure further provides a base station, including the apparatus 800 for allocating D2D resource as described above. FIG. 7 in Embodiment 3 may be referred to for a structure of the base station.

It can be seen from the above embodiment that by transmitting the auxiliary information for assisting the target base station in D2D resource configuration by the source base station to the target base station, in a scenario where the user equipment performs D2D discovery or D2D communication, the target base station may accurately allocate suitable D2D resources even though a handover occurs.

### Embodiment 5

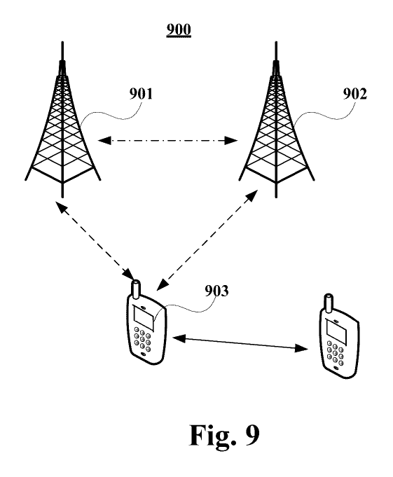

An embodiment of the present disclosure provides a communication system, including the base station according to Embodiment 3 and the base station according to Embodiment 4. FIG. 9 is a schematic diagram of a structure of the communication system of the embodiment of the present disclosure. As shown in FIG. 9, the communication system 900 includes a source base station 901, a target base station 902 and a UE 903.

The source base station 901 is configured to transmit a handover request containing handover preparation information to the target base station 902; the handover preparation information comprises auxiliary information for assisting the target base station in D2D resource configuration; the target base station 902 is configured to receive the handover request transmitted by the source base station 901, and transmit a handover request acknowledgement message to the source base station 901; and the UE 903 is configured to be handed over to the target base station 902 from the source base station 901 in performing D2D discovery or D2D communication.

In this embodiment, the auxiliary information may include: information related to D2D resource configuration information, and information related to a time for transmitting the D2D resource configuration information, with detailed contents being as those described in Embodiment 1.

An embodiment of the present disclosure further provides a computer-readable program, when the program is executed in a base station, the program enables a computer to carry out the method for allocating D2D resource in a handover procedure according to Embodiment 1 or 2 in the base station.

An embodiment of the present disclosure provides a storage medium in which a computer-readable program is stored, the computer-readable program enables a computer to carry out the method for allocating D2D resource in a handover procedure according to Embodiment 1 or 2 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in Figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A method for allocating D2D (device to device) resource in a handover procedure, comprising:
transmitting a handover request containing handover preparation information by a source base station to a target base station; wherein, the handover preparation information comprises auxiliary information for assisting the target base station in D2D resource configuration.

2. The method for allocating D2D resource according to claim 1, wherein the auxiliary information comprises: information related to D2D resource configuration information, and information related to a time for transmitting the D2D resource configuration information.

3. The method for allocating D2D resource according to claim 1, wherein the auxiliary information comprises: D2D discovery resource configuration information or D2D communication resource configuration information allocated by the source base station for a UE (user equipment), and an elapsed time length value of a time for transmitting the D2D discovery resource configuration information or D2D communication resource configuration information by the source base station relative to a current time.

4. The method for allocating D2D resource according to claim 1, wherein the auxiliary information comprises: D2D discovery resource configuration information or D2D communication resource configuration information allocated by the source base station for a UE, and an exact time value for transmitting the D2D discovery resource configuration information or D2D communication resource configuration information by the source base station.

5. The method for allocating D2D resource according to claim 1, wherein the auxiliary information comprises: D2D discovery resource request information or D2D communication resource request information transmitted by a UE, and an elapsed time length value of a time for transmitting the D2D discovery resource configuration information or D2D communication resource configuration information by the source base station relative to a current time.

6. The method for allocating D2D resource according to claim 1, wherein the auxiliary information comprises: D2D discovery resource request information or D2D communication resource request information transmitted by a UE, and an exact time value for transmitting the D2D discovery resource configuration information or D2D communication resource configuration information by the source base station.

7. The method for allocating D2D resource according to claim 1, wherein the method for allocating D2D resource further comprises:
receiving, by the source base station, a handover request acknowledgement message transmitted by the target base station.

8. The method for allocating D2D resource according to claim 7, wherein the handover request acknowledgement message contains D2D resource information configured by the target base station based on the handover preparation information.

9. The method for allocating D2D resource according to claim 7, wherein the method for allocating D2D resource further comprises:
notifying a UE, by the target base station, of using a resource broadcasted in a system information block (SIB).

10. An apparatus for allocating D2D resource in a handover procedure, configured in a resource base station, the apparatus comprising:
a handover request transmitting unit configured to transmit a handover request containing handover preparation information to a target base station; wherein, the handover preparation information comprises auxiliary information for assisting the target base station in D2D resource configuration.

11. The apparatus for allocating D2D resource according to claim 10, wherein the auxiliary information comprises: information related to D2D resource configuration information, and information related to a time for transmitting the D2D resource configuration information.

12. The apparatus for allocating D2D resource according to claim 10, wherein the auxiliary information comprises: D2D discovery resource configuration information or D2D communication resource configuration information allocated by the source base station for a UE, and an elapsed time length value of a time for transmitting the D2D discovery resource configuration information or D2D communication resource configuration information by the source base station relative to a current time.

13. The apparatus for allocating D2D resource according to claim 10, wherein the auxiliary information comprises: D2D discovery resource configuration information or D2D communication resource configuration information allocated by the source base station for a UE, and an exact time value for transmitting the D2D discovery resource configuration information or D2D communication resource configuration information by the source base station.

14. The apparatus for allocating D2D resource according to claim 10, wherein the auxiliary information comprises: D2D discovery resource request information or D2D communication resource request information transmitted by a UE, and an elapsed time length value of a time for transmitting the D2D discovery resource configuration information or D2D communication resource configuration information by the source base station relative to a current time.

15. The apparatus for allocating D2D resource according to claim 10, wherein the auxiliary information comprises: D2D discovery resource request information or D2D communication resource request information transmitted by a UE, and an exact time value for transmitting the D2D discovery resource configuration information or D2D communication resource configuration information by the source base station.

16. The apparatus for allocating D2D resource according to claim 10, wherein the apparatus for allocating D2D resource further comprises:
an acknowledgement message receiving unit configured to receive a handover request acknowledgement message transmitted by the target base station.

17. The apparatus for allocating D2D resource according to claim 16, wherein the handover request acknowledgement message contains D2D resource information configured by the target base station based on the handover preparation information.

18. A communication system, comprising:
a source base station configured to transmit a handover request containing handover preparation information to a target base station; wherein, the handover preparation information comprises auxiliary information for assisting the target base station in D2D resource configuration;
the target base station configured to receive the handover request transmitted by the source base station, and transmit a handover request acknowledgement message to the source base station; and
a user equipment configured to be handed over to the target base station from the source base station in performing D2D discovery or D2D communication.
